(19) United States
(12) Patent Application Publication
(10) Pub. No.: US 2009/0136331 A1
(43) Pub. Date: May 28, 2009

(54) Manipulation device for loading and unloading a shelf

(76) Inventor: Miguel Muser, Seiersberg (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 12/292,394

(22) Filed: Nov. 18, 2008

(30) Foreign Application Priority Data
Nov. 22, 2007 (AT) A 1894/2007

(51) Int. Cl. B60P 1/52; B60P 3/14

(52) U.S. Cl. 414/529

(57) ABSTRACT

The invention relates to a manipulation device for loading and unloading a shelf, in particular for a processing center, having at least one lift truck including a telescopic extension, the telescopic extension having at least one first telescoping part and at least one second telescoping part, and the first telescoping part being connected to the lift truck and the second telescoping part being connected to the first telescoping part so it is displaceable in an essentially horizontal displacement direction. To reduce the manufacturing expenditure, it is provided that the lift truck has at least one first linear roller bearing unit and at least one support roll, spaced apart from the first linear roller bearing unit in the displacement direction, in the area of sides parallel to the displacement direction, and each first telescoping part has at least one first profiled rail situated parallel to the displacement direction, each first linear roller bearing unit being guided in a first profiled rail, and the first telescoping parts being supported by the support rolls of the lift truck.

### BACKGROUND OF THE INVENTION

The invention relates to a manipulation device for loading and unloading a shelf, in particular for a processing center, having at least one lift truck comprising a telescopic extension, the telescopic extension having at least one first telescoping part and at least one second telescoping part, and the first telescoping part being connected to the lift truck and the second telescoping part being connected to the first telescoping part so it is displaceable in an essentially horizontal displacement direction.

### DESCRIPTION OF THE PRIOR ART

A device for the transverse movement of a load receiving means in an overhead system for operating storage units is known from WO 03/040021 A1, which comprises a horizontally displaceable stage, on which telescopically interlocking pushing elements are implemented in such a way that an overall size is provided in a first state which essentially corresponds to the overall size of the largest pushing element. In the extended state, the pushing elements project significantly beyond one side of the stage.

A telescopic conveyor for the horizontal handling of loads is known from DE 100 65 084 A1, which has a base profile and a middle profile, which comprise cost-effective molded profiles.

EP 1 431 237 A1 describes a load support framework for a shelf operating device having a support framework fastenable to a lift carriage of the conveyor device and having support devices, situated parallel to one another thereon, having expandable telescopic support arms for accommodating a loading aid, such as a palette, box, etc. Furthermore, the load support framework has a conveyor unit running parallel to the adjustment direction of the support devices, which is formed by two conveyor devices, which each comprise linear conveyors situated symmetrically in relation to a central plane running perpendicularly to a set-up area of the shelf operating device between the support devices, which implement a conveyor direction parallel to an adjustment direction of the support devices. Central spacings of the linear conveyors running perpendicular to the central plane are greater than a central distance of the support devices.

Known manipulation devices are implemented as two-stage to three-stage telescopes, which are guided over rolls. Rolls may be mounted having very large bearing spacings, because they may also leave their guide groove. To ensure the required rigidity and reduce the play of the extensions, until now, complex groove runways having precise tolerances have had to be milled. Upon use in processing centers, the problem additionally results that an extremely large number of metal chips occur, because of which special skimming systems are necessary.

Using profiled rail roller bearing guides, which are less susceptible to contamination by metal chips, is known from the field of machine tools.

A profiled rail recirculating ball guide having a truck is known from DE 43 31 511 C2, which engages using guide legs around a guide rail, which is provided with an expanded head, on opposite sides and from above, the truck being guided so it is linearly movable via balls situated between the guide legs and the guide rail.

DE 33 38 751 A1 describes a linear roller bearing, which is suitable for guiding a back-and-forth movement at high speed. The linear roller bearing comprises a bearing cage which is implemented from a light material, for example, from artificial resin or aluminum.

Furthermore, a linear drive unit having a first machine part and a second machine part is known from DE 103 12 008 A1, a first linear roller bearing being situated between the two machine parts. A first guide truck of the first linear roller bearing is roller-mounted on a first toothed rack rail, a first drive pinion engaging with the first toothed rack rail.

### SUMMARY OF THE INVENTION

The object of the invention is to avoid the cited disadvantages and provide a manipulation device which may be manufactured with little production expenditure.

This is achieved according to the invention in that the lift truck has at least one first linear roller bearing unit and at least one support roll, which is spaced apart from the first linear roller bearing unit in the displacement direction, in the area of sides parallel to the displacement direction, and each first telescoping part has at least one first profiled rail situated parallel to the displacement direction, each first linear roller bearing unit being guided in a first profiled rail, and the first telescoping parts being supported by the support rolls of the lift truck.

To be able to absorb high forces, it is advantageous if the lift truck has two first linear roller bearing units situated one above another on each side, which are guided in corresponding second profiled rails of the first telescoping part situated one above another.

Especially simple production results if the lift truck has a girder part on each side, on which the linear roller bearing units and support rolls are attached.

In a further embodiment of the invention, it is provided that each second telescoping part has at least one second linear roller bearing unit and each first telescoping part has at least one profiled rail situated parallel to the displacement direction, the second linear roller bearing units being guided in the second profiled rails, preferably each second telescoping part having two second linear roller bearing units situated one above another, which are guided in second profiled rails of the first girder part correspondingly situated one above another.

A space-saving embodiment which is simple to manufacture provides that the first and second profiled rails are situated on different sides of each first telescoping part.

To allow large lifting distances in both extension directions with high stability, it is advantageous if the first linear roller bearing units are situated approximately in the area of a central plane of the lift truck situated perpendicularly to the displacement direction.

A space-saving and simple drive of the first telescoping part is made possible if at least a first telescoping part has a toothed rack, in which a drive gearwheel mounted so it is rotatable on the girder part engages. It is especially advantageous if the first telescoping part has an endless traction means, which is connected in areas spaced apart equally from one another on the traction means to the lift truck, preferably to the girder part, and to the second telescoping part. Both the first and also the second telescoping part may thus be driven simultaneously using the drive gearwheel.

### BRIEF DESCRIPTION OF THE DRAWINGS

The invention is explained in greater detail hereafter on the basis of the figures. In the figures:

FIG. 1 shows a manipulation device according to the invention in a diagonal view;

FIG. 2 shows the manipulation device in a section along line II-II in FIG. 1;

FIG. 3 shows a telescopic extension of the manipulation device in a diagonal view;

FIG. 4 shows the telescopic extension in a side view;

FIG. 5 shows the telescopic extension in a top view;

FIG. 6 shows the telescopic extension in a front view in detail;

FIG. 7 shows detail VII from FIG. 5;

FIG. 8 shows a linear roller bearing unit in a diagonal view; and

FIG. 9 shows the linear roller bearing unit in a cross-section.

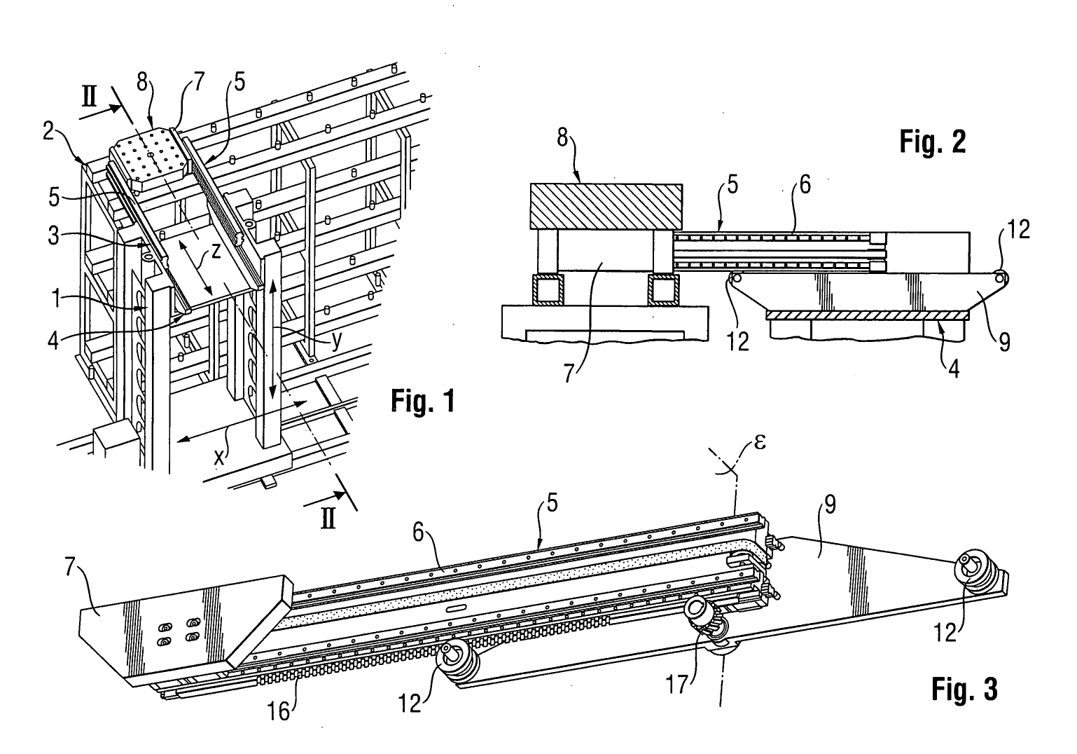

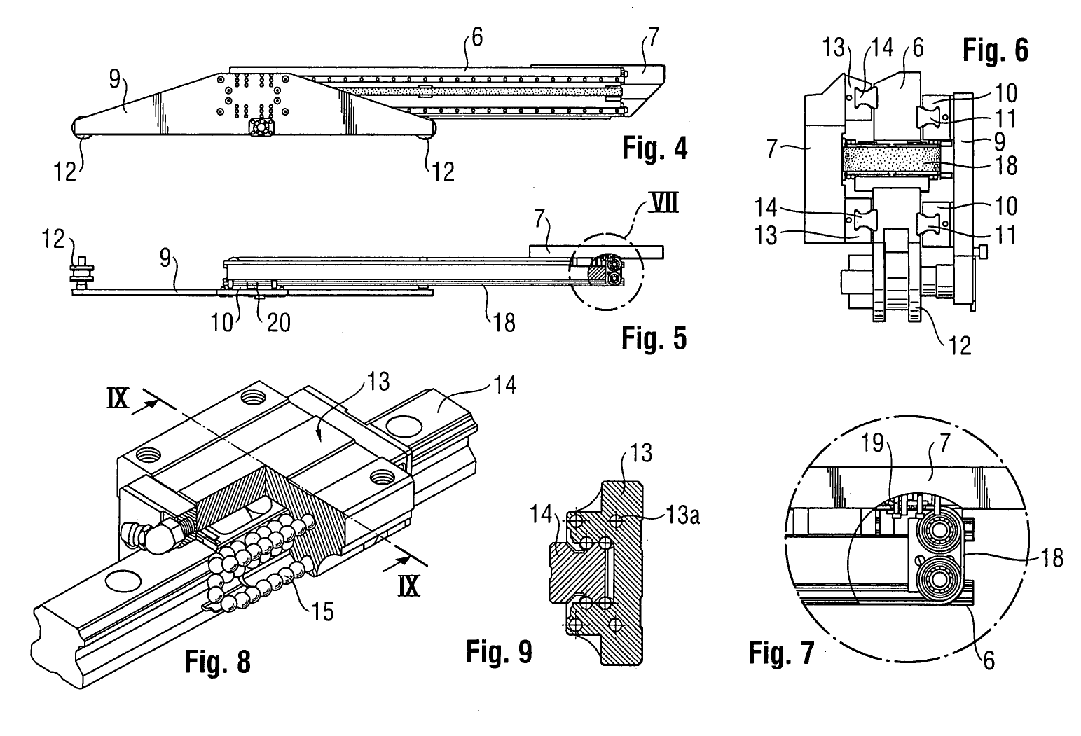

### DETAILED DESCRIPTION OF THE PREFERRED EMBODIMENTS

The manipulation device 1 for loading and unloading a shelf 2 is movable in the directions x, y, and z. For the movement in the z direction, the manipulation device 1 has a truck unit 3 having a lift truck 4 and two laterally situated telescopic extensions 5. Each telescopic extension 5 comprises a first telescoping part 6 and a second telescoping part 7, a palette 8 being able to be accommodated between the two second telescoping parts 7. The accommodation of the palette 8 may be performed by lifting from below or by lateral engagement on a palette 8 by lateral telescoping forks or the like. The lift truck 4, which may be moved in the vertical lifting direction y via a mechanism (not shown in greater detail), has a support part 9 on each side parallel to the displacement direction z, on which two first linear roller bearing units 10 are situated one above another in the area of a central plane E perpendicular to the displacement direction z in each case. The two first linear roller bearing units 10 are guided in first profiled rails 11 of the first telescoping part 6. To support the first telescoping part 6, two support rolls 12 spaced as far apart as possible from the first linear roller bearing unit 10 are situated on each girder part 9, for example, in the area of the corners of the lift truck 4. The first telescoping part 6 is thus supported in each extension direction z. An ultrahigh-precision positioning of the manipulation device 1 is possible by the support rolls 12, without complexly produced guide grooves being necessary.

Second linear roller bearing units 13, which are guided in second profiled rails 14, are also situated one above another on the second telescoping parts 7. The second profiled rails 14 are attached to the first telescoping part 6 parallel to the extension direction z, the first profile rails 11 and the second profiled rails 14 being fastened on different sides of the telescoping parts 6. A second linear roller bearing unit 13 including second profiled rail 14 is shown in detail in FIG. 8 and FIG. 9. The recirculating balls 15 in the guides 13a of the second linear roller bearing 13 are clearly visible. The linear roller bearings 10, 13 are capable of absorbing forces in both vertical directions y and in both horizontal directions z. Additional roller guides in these directions are thus dispensed with.

The first and second telescoping parts 6, 7 are driven via a toothed rack 16, attached to the bottom side of the first telescoping part 6, in which a drive pinion 17 of a drive unit (not shown in greater detail), mounted so it is rotatable on the girder part 9, engages. Furthermore, the first girder part 6 has an endless traction means 18, formed by a belt, for example, which is connected via fastening pins 19 to the second telescoping part 7 on the one hand and via fastening pins 20 to the girder part 9 on the other hand. The second telescoping part 7 is extended by the displacement movement of the first telescoping part 6 via drive pinion 12 and toothed rack 16 using the traction means 18, which may also be a chain.

What is claimed is:

1. A manipulation device for loading and unloading a shelf, in particular for a processing center, having at least one lift truck comprising a telescopic extension, the telescopic extension having at least one first telescoping part and at least one second telescoping part, and the first telescoping part being connected to the lift truck and the second telescoping part being connected to the first telescoping part so it is displaceable in an essentially horizontal displacement direction, wherein the lift truck has at least one first linear roller bearing unit and at least one support roll, spaced apart from the first linear roller bearing unit in a displacement direction, in an area of sides parallel to the displacement direction, and each first telescoping part has at least one first profiled rail situated parallel to the displacement direction, each first linear roller bearing unit being guided in a first profiled rail, and the first telescoping parts being supported by the support rolls of the lift truck.

2. The manipulation device according to claim 1, wherein the lift truck has two first linear roller bearing units situated one above another on each side, which are guided in corresponding second profiled rails, situated one above another, of the first telescoping part.

3. The manipulation device according to claim 1, wherein the lift truck has a girder part on each side, on which the linear roller bearing units and support rolls are attached.

4. The manipulation device according to claim 1, wherein each second telescoping part has at least one second linear roller bearing unit and each first telescoping part has at least one second profiled rail situated parallel to the displacement direction, the second linear roller bearing units being guided in the second profiled rails.

5. The manipulation device according to claim 4, wherein each second telescoping part has two second linear roller bearing units situated one above another, which are guided in corresponding second profiled rails, situated one above another, of the first girder part.

6. The manipulation device according to claim 4, wherein the first and second profiled rails are situated on different sides of each first telescoping part.

7. The manipulation device according to claim 1, wherein the first linear roller bearing units are situated approximately in the area of a central plane of the lift truck situated perpendicularly to the displacement direction.

8. The manipulation device according to claim 1, wherein at least one first telescoping part has a toothed rack, in which a drive gearwheel, which is mounted so it is rotatable on the girder part, engages.

9. The manipulation device according to claim 1, wherein the first telescoping part has an endless traction means, which is connected in areas spaced apart equally from one another on the traction means to the lift truck and to the second telescoping part.

10. The manipulation device according to claim 1, wherein the first telescoping part has an endless traction means, which is connected in areas spaced apart equally from one another on the traction means to the girder part and to the second telescoping part.
